(19) United States
(12) Patent Application Publication
(10) Pub. No.: US 2012/0319369 A1
(43) Pub. Date: Dec. 20, 2012

(54) Cutting edge handlers for plows and graders

(76) Inventor: Jerry Miller, West Jefferson, MD (US)

(21) Appl. No.: 13/134,943

(22) Filed: Jun. 20, 2011

(51) Int. Cl. B62B 1/10; B62B 1/00

(52) U.S. Cl. 280/47.24

(57) ABSTRACT

A device for handling blades of a plow or grader has a frame having a front end and a rear end, the frame defining a handle at the rear end. The device also includes a front plate having a rear face secured to the front end of the frame, the front plate oriented perpendicular to the frame, and having a guide pin extending from a front face of the front plate adjacent each of the first and second opposite ends of the front plate. An axle assembly is secured to the frame slightly proximal to the front plate, the axle assembly including an axle shaft secured to the frame, and two wheels carried on opposite ends of the axle shaft.

### BACKGROUND OF THE INVENTION

1. Field of the Invention The present invention relates generally to accessories used with plows (e.g., snow plows) and graders. More particularly, the present invention concerns a device for use in replacing replaceable blades, such as cutting edges and wear plates that are used on plows and graders.

2. Description of the Prior Art

The need to remove snow from roads and highways necessitates the use of snow plow trucks.

Motor graders are also widely used in all seasons, especially in the southern part of the United States. They dress and level roads and road bases made of sand, clay and gravel.

Graders, like snow plow trucks, need to have their cutting edges or blades (hereinafter collectively referred to as “blades”) changed routinely. Graders and snow plow trucks differ slightly from place to place, but all have one thing in common. The blade on the snow plow and grader edges eventually wears out. It is not uncommon for mechanics to change out the blades two or three times per season depending on the amount of snow fall, quality of steel construction of the edge, etc. Grader blades are changed more or less often depending on project demand, the amount of material abrasion, structural failure, etc.

The procedure for changing a bolt-on blade is much the same for snow plow trucks and motor graders, and is very labor intensive. It requires the mechanic or maintenance person to lie on the ground at times, and hand mount the blades by lifting them into place and holding them with one hand while inserting the bolts or fasteners with the other hand. One of the most common Worker's Compensation claims are injured hands or fingers and/or back injuries related to blade installation.

Therefore, there still remains a need for a device that allows snow plow or grader blades to be changed while minimizing injuries to the mechanic or maintenance person.

### SUMMARY OF THE DISCLOSURE

It is an object of the present invention to simplify and facilitate the replacement of the blade of a plow or grader.

It is another object of the present invention to provide a device that permits the blade to be replaced by only one worker, without requiring the worker to manually hold the blade off of the ground during replacement.

In order to accomplish the objects of the present invention, the present invention provides a device for handling blades of a plow or grader. The device has a frame having a front end and a rear end, the frame defining a handle at the rear end. The device also includes a front plate having a rear face secured to the front end of the frame, the front plate oriented perpendicular to the frame, and having a guide pin extending from a front face of the front plate adjacent each of the first and second opposite ends of the front plate. An axle assembly is secured to the frame slightly proximal to the front plate, the axle assembly including an axle shaft secured to the frame, and two wheels carried on opposite ends of the axle shaft.

### BRIEF DESCRIPTION OF THE DRAWINGS

FIG. 1 is front plan view of handling device according to one embodiment of the present invention.

FIG. 2 is a side plan view of the device of FIG. 1.

FIG. 3 is a top plan view of the device of FIG. 1.

FIGS. 4 and 5 illustrate the use of the device of FIG. 1.

FIG. 6 is a top plan view of a handling device according to another embodiment with a different handle.

### DETAILED DESCRIPTION OF THE PREFERRED EMBODIMENTS

The following detailed description is of the best presently contemplated modes of carrying out the invention. This description is not to be taken in a limiting sense, but is made merely for the purpose of illustrating general principles of embodiments of the invention. The scope of the invention is best defined by the appended claims.

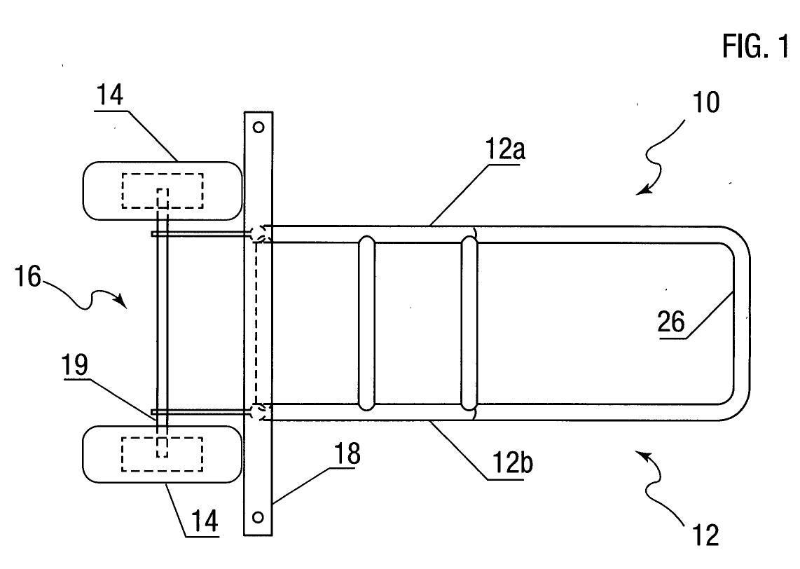

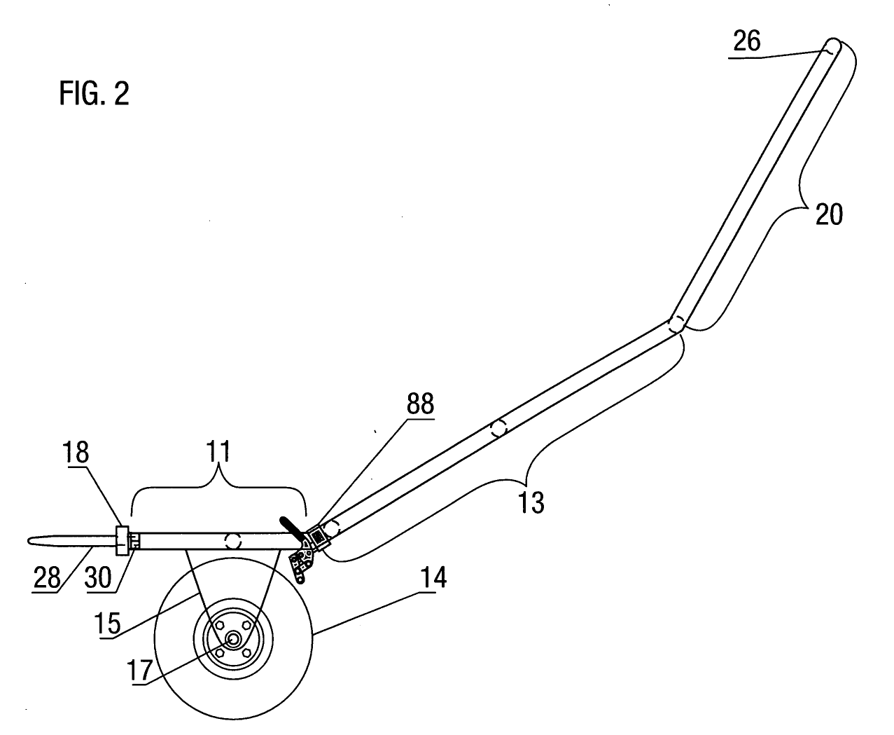

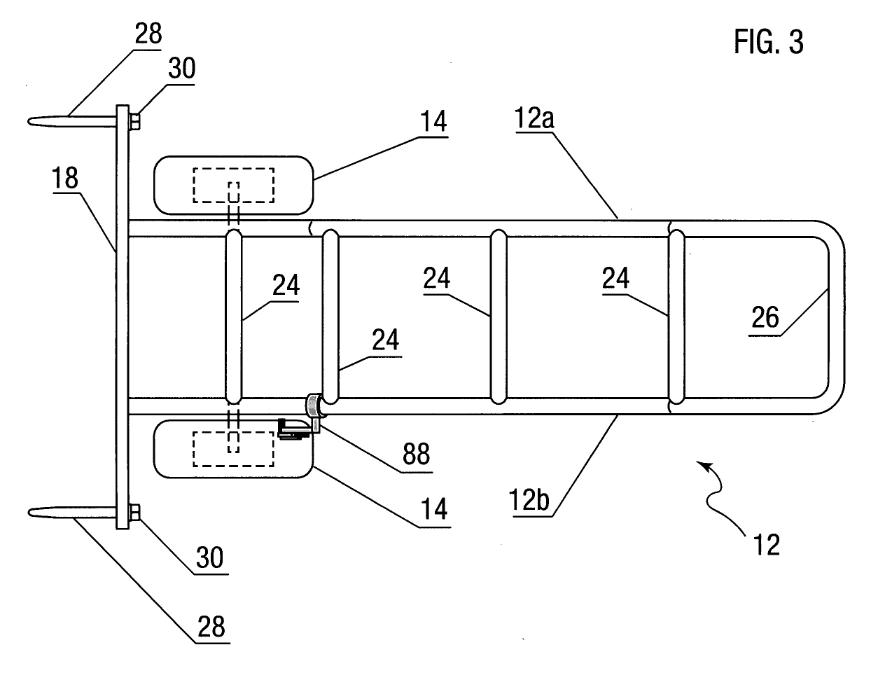

Referring to FIGS. 1-3, the handling device 10 comprises a portable cart designed to assist the operator in installing and removing the replaceable blades of a plow or grader. As will subsequently be described, the device 10 permits a single user to install a blade, without having to handle or hold the blade during removal and installation. The device 10 generally includes a frame 12, a pair of wheels 14 carried on an axle assembly 16, and a front plate 18.

The frame 12 can be made of either square or round tubular steel, and extends as left and right bars 12a and 12b, respectively, that are connected by a handle bar 26 at its proximal-most end. The frame 12 includes a first straight portion 11 extending from the front end, a second straight portion 13 that is angled (e.g., by about 160 degrees) from the first straight portion 11, and a third straight handle portion 20 that is angled (e.g., by about 160 degrees) from the second straight portion. The entire frame 12 can be approximately five feet long, with the first straight portion about one foot long, the second straight portion 13 about two feet long, and the handle portion 20 about two feet long so to give the user more control of height and leverage. The bars 12a, 12b and the handle bar 26 can be made of conventional one-inch diameter tube steel stock that is commonly used for hand trucks. The left and right bars 12a and 12b are attached to cross braces 24 that keep them together so as to form one combined “frame/handle” assembly. The cross braces 24 can be one-inch diameter tubular steel. From the front end (defined by the front plate 18) to the rear end (defined by the handle bar 26), the frame 12 is approximately 12 inches wide.

Each bar 12a, 12b has a generally triangular support plate 15 that has an axle shaft hole 17 provided adjacent its lower corner. The support plates 15 can be welded to the bars 12a, 12b along the first straight portion 11, and can have a thickness of about a quarter of an inch. Each plate 15 can have an upper side that is about six inches in length welded to the corresponding bar 12a or 12b, with the ends of the upper side tapering down at an angle to form the lower corner.

A steel axle assembly 16 has an axle shaft 19 that extends through the holes 17 in the plates 15 to secure the axle assembly 16 to the frame 12. The axle shaft 19 is located approximately 9 inches proximal from the front plate 18. Two wheels 14 are carried on opposite ends of the axle shaft 19. The axle shaft 19 can have a diameter of about ⅝ inches, and the wheels 14 can be pneumatic tires having a diameter of ten inches.

The front plate 18 can be a 1.75″×26″ long piece of heavy plate steel that is angle-welded to the front end of the frame 12 in a manner such that it is perpendicular to the left and right bars 12a and 12b. The front plate 18 can have a thickness of about ¾ inch. In addition, the front plate 18 has a width that extends beyond the width of the frame 12 (i.e., as defined by the left and right sides 12a and 12b), and even extends beyond the wheels 14, as viewed from the front in FIG. 1. A tapered steel guide pin 28 is secured by a bolt nut 30 through openings in the front plate 18 about one inch from each end of the front plate 18. Therefore, if the front plate 18 has a length of 26 inches, then the distance between the guide pins 28 will be 24 inches. The guide pins 28 are parallel to the left and right bars 12a and 12b, and extend forwardly like “horns”, and can be about seven inches in length with a diameter of ⅝ inches. In this regard, snow plow and grader blades, as well as most construction blades, have bolt holes that are spaced apart by either 6″, 8″, or 12″ spacings. Therefore, by providing the guide pins 28 with a 24″ spacing, the device 10 can be used with all three configurations.

The device 10 utilizes leverage to lift and carry a load, similar to a hand truck or wheelbarrow, but is singularly unique in its function, and provides a specific solution to a long term problem in the construction and road maintenance industry. The device 10 solves this problem by limiting, or eliminating completely, the need to handle the blades directly.

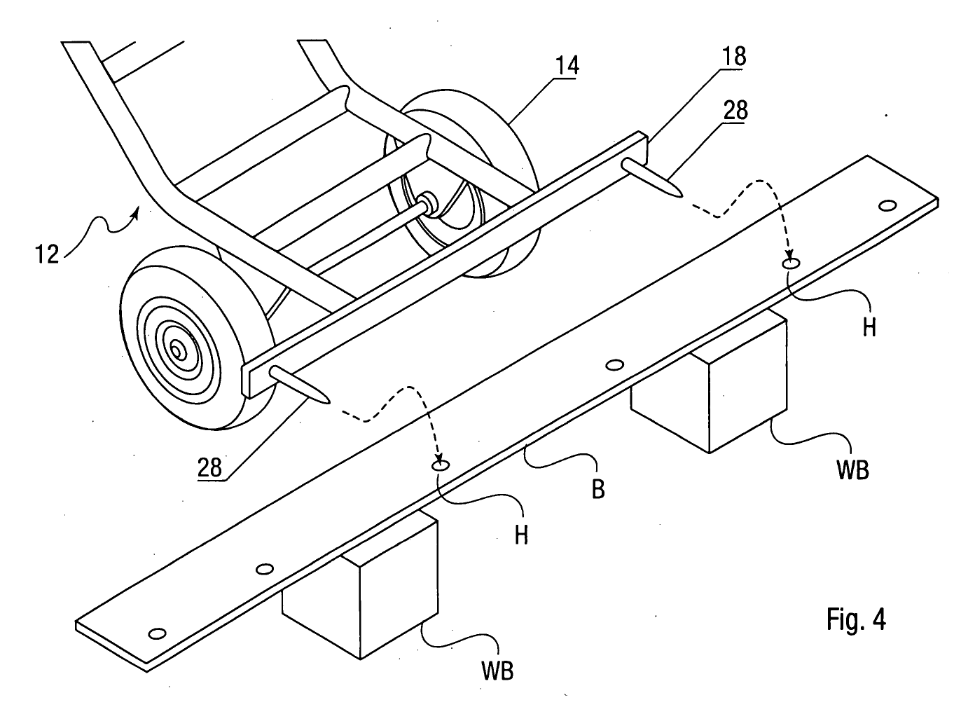

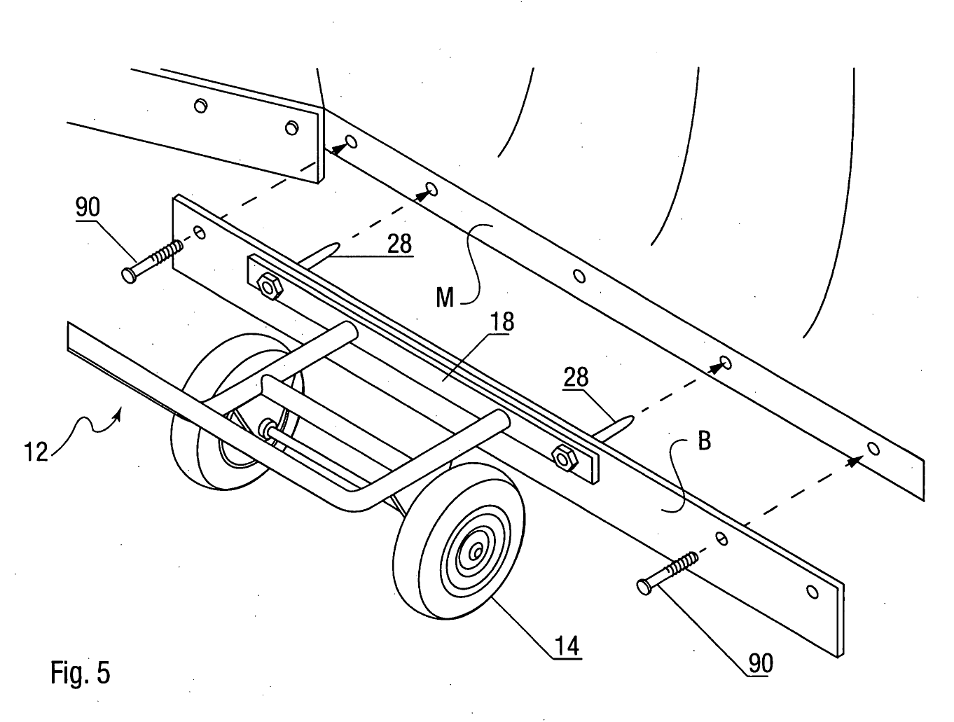

In use, the installer could use a pry or wrecking bar to slide the blade on to wooden blocks, as is commonly done now. However, instead of manually picking up the blade and carrying it to the plow truck or grader moldboard, the installer can now use the device 10 in the following manner, as shown in FIGS. 4 and 5. First, the device 10 is rolled to the location of the blade B, which is usually on the wooden blocks WB. See FIG. 4. Next, the device 10 is raised (i.e., the wheels 14 are raised) to align the guide pins 28 into two corresponding bolt holes H of the blade B, and the guide pins 28 are pushed through the bolt holes H as far as they will go, causing them to protrude out from the point of entry in the front of the blade B, through the back side of the blade B. Next, the installer grasps the handle bar 26 and simply pushes the device 10 down, creating a “cantilever” effect which would (as soon as the wheels 14 touch the ground) lift the blade B up with very little effort. The installer can then push/roll the device 10 (with the blade B carried thereon) to the plow or moldboard and align the protruding guide pins 28 with the corresponding holes on the moldboard M, and then push the blade B into place. See FIG. 5. The guide pins 28 will hold the device 10 and new blade B in place while the installer installs the bolts 90.

As a result, the installer or mechanic does not have to get his/her fingers into a position that could cause injury. The guide pins 28 will securely hold the blade in position, but for safety, a universal wheel lock 88 can be provided in the frame 12 to prevent the device 10 from rolling during use.

In addition, the device 10 reduces the need for two people to change a blade. It reduces the chance of injury to fingers, hands, backs and feet, and makes the replacement of blades safer, easier, faster and far more efficient.

The device 10 can also be used on similar construction or excavating equipment that require bolt-on replacement blades, such as Bulldozers, Front End Loaders, Backhoes and Excavators. In addition, even though the device 10 is designed for field use, it can also be used in a garage.

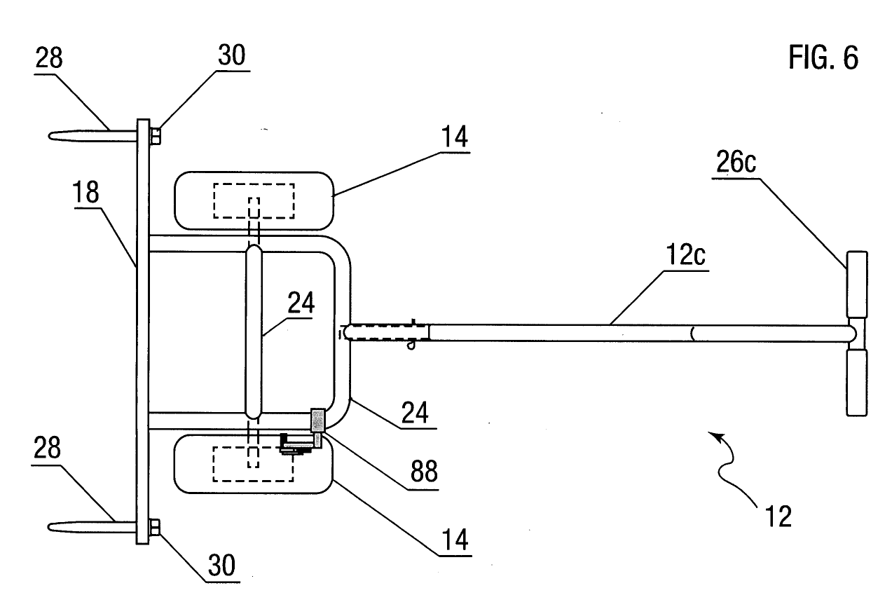

FIG. 6 illustrates a modification that can be made to the handle of device 10. The device 10 can be modified so that the portions 13 and 20 do not have separate side bars 12a and 12b, but where a single bar 12c extends along the center axis to a T-handle 26c.

While the description above refers to particular embodiments of the present invention, it will be understood that many modifications may be made without departing from the spirit thereof. The accompanying claims are intended to cover such modifications as would fall within the true scope and spirit of the present invention.

What is claimed is:

1. A device for handling blades of a plow or grader, comprising:
a frame having a front end and a rear end, the frame defining a handle at the rear end;
a front plate having a front face and a rear face, the rear face secured to the front end of the frame, the front plate oriented perpendicular to the frame, and having opposite first and second ends, with a guide pin extending from the front face of the front plate adjacent each of the first and second ends of the front plate; and
an axle assembly secured to the frame slightly proximal to the front plate, the axle assembly including an axle shaft secured to the frame, and two wheels carried on opposite ends of the axle shaft.

2. The device of claim 1, wherein each guide pin is approximately seven inches long.

3. The device of claim 1, wherein the frame includes a first straight portion extending from the front plate, a second straight portion that is angled from the first straight portion, and a third straight portion that is angled from the second straight portion, the third straight portion defining the handle.

4. The device of claim 3, wherein the axle assembly is secured to the first straight portion.

5. The device of claim 1, wherein the frame comprises a left bar and right bar connected by cross braces.

6. The device of claim 1, wherein the guide pins are separated by 24 inches.

7. The device of claim 1, wherein the frame has a single bar terminating at a T-shaped handle.
